(19) United States
(12) Patent Application Publication
(10) Pub. No.: US 2011/0279083 A1
(43) Pub. Date: Nov. 17, 2011

(54) CHARGING SYSTEM FOR ELECTRIC VEHICLE

(75) Inventors: Yasuo Asai, Aichi (JP); Nobuo Momose, Tokyo (JP); Kenichi Tsutsumi, Tokyo (JP)

(73) Assignees: MITSUBISHI JIDOSHA KOGYO KABUSHIKI KAISHA, Tokyo (JP); JAPAN DELIVERY SYSTEM CORPORATION, Nagoya-shi, Aichi (JP)

(21) Appl. No.: 13/146,115

(22) PCT Filed: Jan. 26, 2010
(86) PCT No.: PCT/JP2010/050978

§ 371 Date: Jul. 25, 2011

(30) Foreign Application Priority Data
Jan. 27, 2009 (JP) 2009-015362

(51) Int. Cl. H02J 7/00

(52) U.S. Cl. 320/109

(57) ABSTRACT

A charging system of electric vehicles comprises: a delivery box 100 having a plurality of article storage boxes 104 each locked or unlocked by electrically operated locking devices 1042, 1043, the article storage boxes 104 being used to receive delivered or mailed articles in apartment buildings; delivery box controller 101 for controlling locking and unlocking of the locking devices 1042, 1043; a power supply circuit 202 for electrically charging the electric vehicles 300; and a control circuit 201 for controlling the power supply circuit 202, wherein the delivery box controller 101 regulates electrically charging services of the electric vehicles through the power supply circuit 202 and electrification controller 201 in addition to controlling operation of the locking devices 1042, 1043 for the delivery box 100.

### TECHNICAL FIELD

This invention relates to an electrically charging system for electric vehicles applicable to apartment houses or condominium buildings that provide article storages such as home-delivery boxes.

### BACKGROUND ART

It is common knowledge that vehicles driven by electric motors and powered by rechargeable battery such as electric vehicles or electric bicycles are effective to preserve natural energy resources such as petroleum oil or to prevent global worming by reduction in amount of carbon dioxide in the atmosphere. Whereas there are many gas stations that supply fuel to automobiles running on oil by conventional fuel supply services, it is necessary to electrically charge rechargeable batteries equipped in electric vehicles or electric bicycles (collectively referred herein as to “electric vehicles”). Electric vehicles are disadvantageous because they need to spend more time in electrification than quick fueling of petroleum or light oil to automobiles.

In this connection, electric vehicles actually have to individually achieve the time-consuming electric battery charge in domestic garages or parking lots, parking areas or shared spaces of apartment buildings such as condominiums during their parking. This situation is true on car-shared or common systems where several households or general public may share a single electric car in apartment buildings such as condominiums, and these systems need to secure at least one space for electric battery charge.

In particular, apartment buildings such as condominiums need car parks allocated for each household or family or a dedicated space to electrically charge the batteries. However, this case may raise a problem how to manage billing or charging of electrification fees incurred for electric charge, and this problem provides an impediment against popularization of electric vehicles.

To solve the problem on how residents pay electrification fees in apartment buildings such as condominiums, for example, Patent Document 1 as below offers a system to install an automatic dispenser of electricity that may dispense a corresponding quantity of electricity to the amount of consideration paid by insertion of money or prepaid cards. However, this system is not always convenient for residents because they have to receive electric charging services while paying cash or using prepaid cards in parking lots or rechargeable space of apartment buildings, and it is believed that residents do not necessarily have good image of such a system.

### CITATION LIST

### Patent Literature

[PTL 1]: Japanese Patent Disclosure No. 6-231361

### SUMMARY OF INVENTION

### Technical Problem

On the other hand, some apartment buildings such as condominiums may comprise article storages (for simplification, referred herein collectively as to “delivery boxes”) such as mailboxes and home-delivery boxes. Delivery boxes serve as article storages like lockers that comprise a plurality of lockable article boxes for receiving delivered or shipped baggage, luggage or package addressed to or sent by specific one of residents. Sometimes, this article storage box may be in common use by residents, but on the contrary, there may be another available configuration of the article storage box wherein a single dedicated article storage box is exclusively allocated to each resident that may also utilize the dedicated storage box as a mailbox.

One of residents may use an operation board of the touch panel type in the delivery box of this kind to operate a control circuit when he or she unlocks or locks a plurality of article storage boxes to put baggage in or take baggage out of the boxes. For example, residents are previously and individually assigned ID cards (such as IC cards) that may be accessed to the operation board to prove or authenticate a fact that the operator is a true addressee or sender when he or she wants to put baggage in or take baggage out of article storage boxes, and after identification of the operator, the control circuit may be operated in accordance with the predetermined sequence for unlocking or locking a selected article storage box. The executed operations to the article storage box are recorded in database as utilization information for monitoring and management together with used clock time, identification information on the operator shown by the ID card. The administrative information on use or utilization of article storage boxes is retained or stored in a memory device of the control circuit while the administrative information may be indicated on a display of the operation board or may be forwarded to a remote control center through communication networks.

Recently, the number of cooperative dwellings such as condominium buildings has increased that provide home-delivery box systems comprised of a control circuit for locking and unlocking lock devices provided in each home-delivery boxes, a memory device for storing identification numbers of residents and database for systematically storing information on articles, services and users to identify residents by means of for example ID cards, and it is expected that such home-delivery box systems will be more convenient for residents if they are also used to control and manage electrically charging operations for electric vehicles and their billing information in addition to control of home-delivery boxes. This idea may provide the feasibility of creating a simple integrated system for dual function of concurrently controlling home-delivery boxes and electrically charging system for electric vehicles to enhance the convenience of the residents. In this case, it is believed that people can share the combined system for controlling home-delivery boxes and electrically charging system, thereby totally saving the cost required for the whole facilities and system administrations in the apartment buildings.

It is therefore an object of the present invention to commoditize a control system of home-delivery boxes and electrically charging and control system for electric vehicles to achieve a unified control of home-delivery boxes and electrically charging system for electric vehicles and to thereby reduce a total cost necessary for whole facilities and system administrations in apartment buildings.

### Solution to Problem

To solve the foregoing problem, the present invention provides a charging system that comprises a delivery box having a plurality of article storage boxes for receiving delivered or mailed articles in apartment buildings, electrically operated locking devices for locking and unlocking each storage box, and control means for controlling locking and unlocking of the locking devices, a power supply circuit for electrically charging electric vehicles and an electrification controller for controlling the power supply circuit wherein the control means also regulates electrically charging services of electric vehicles through the power supply circuit and electrification controller in addition to controlling operation of the locking devices for the article storage boxes.

### Advantageous Effects of Invention

In accordance with the above-mentioned configuration of the charging system, the control means in the delivery box may be also used to control charging services for electric vehicles while combining, integrating or unifying the control system for the delivery box and the charging system for electric vehicles to thereby reduce the total cost incurred for the whole facilities and system management required in apartment buildings.

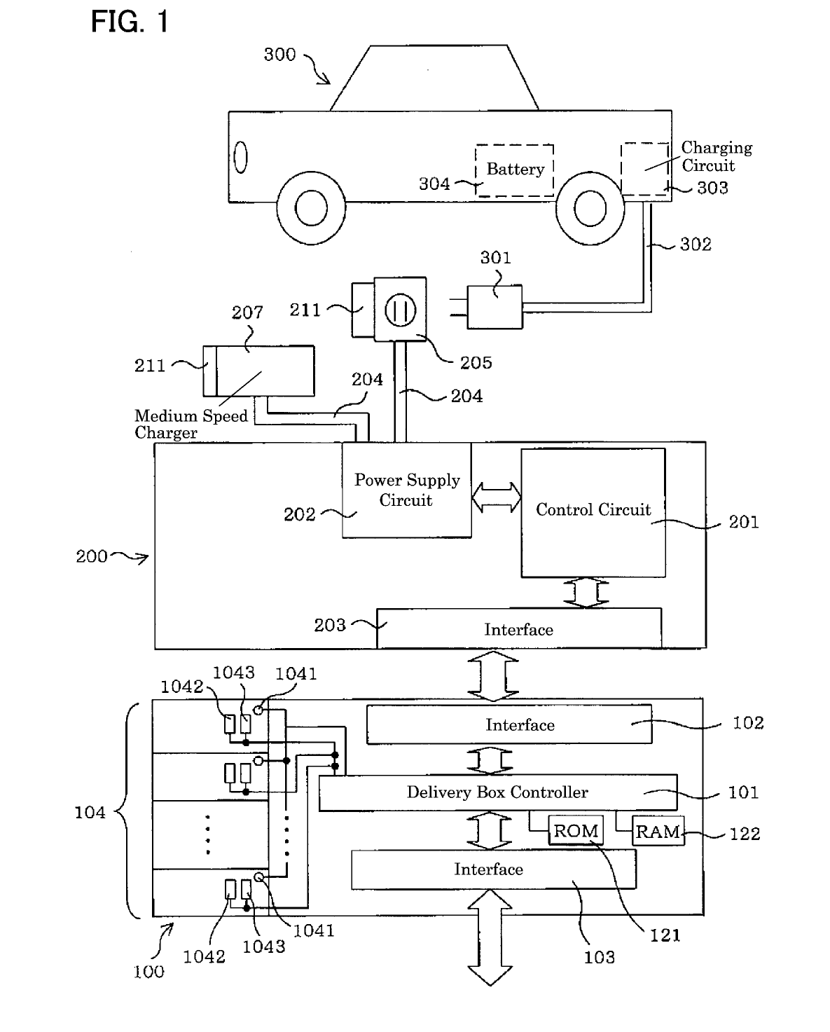

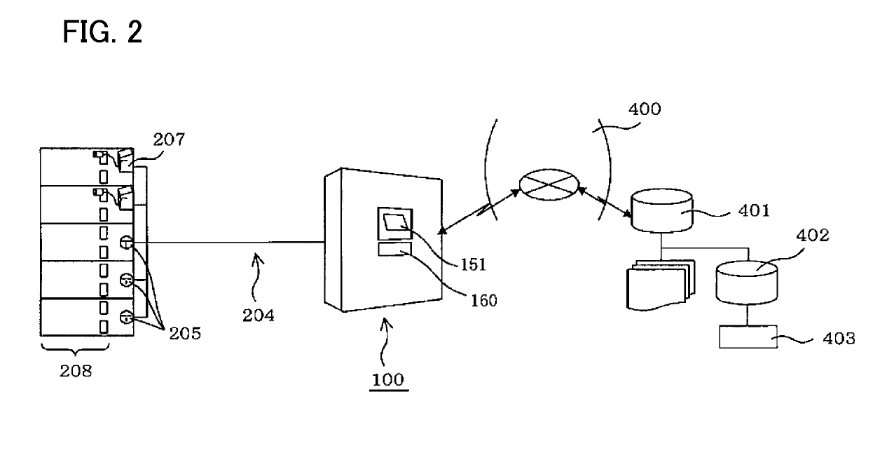

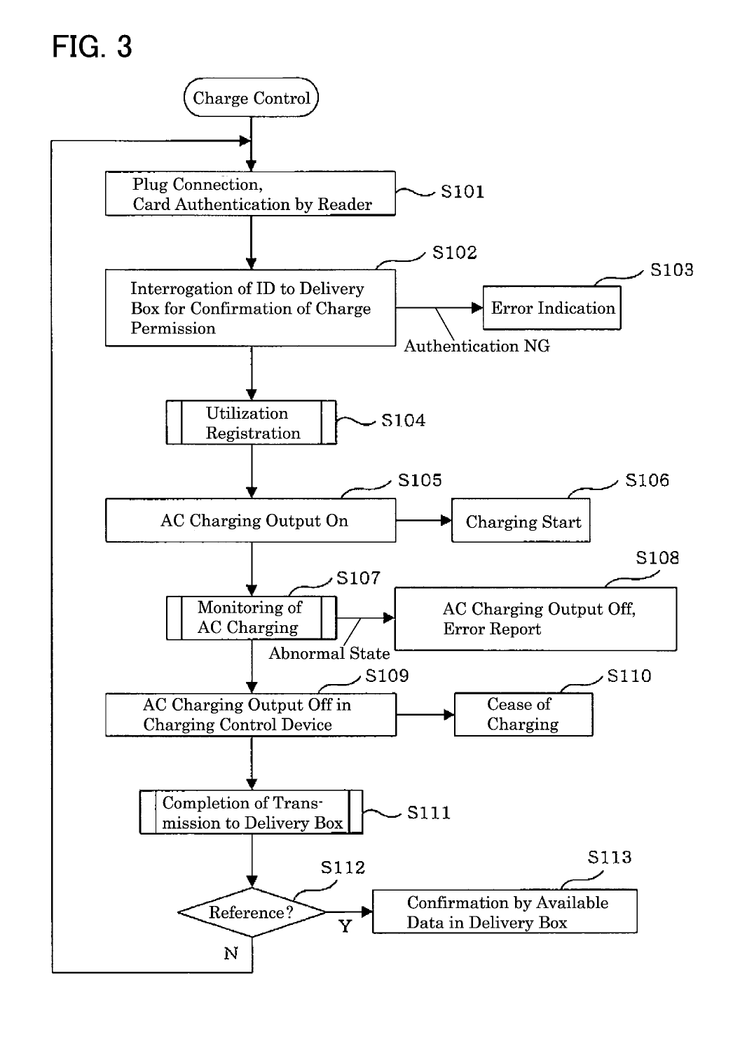

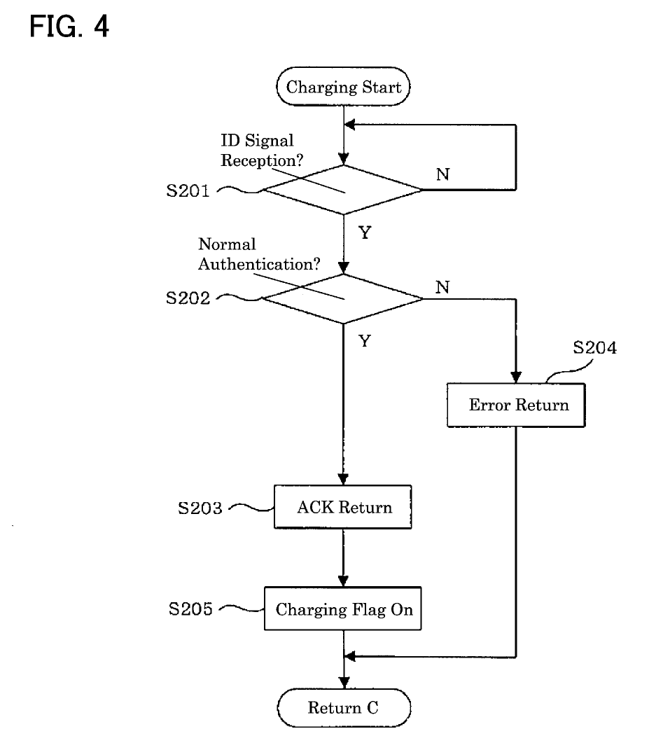

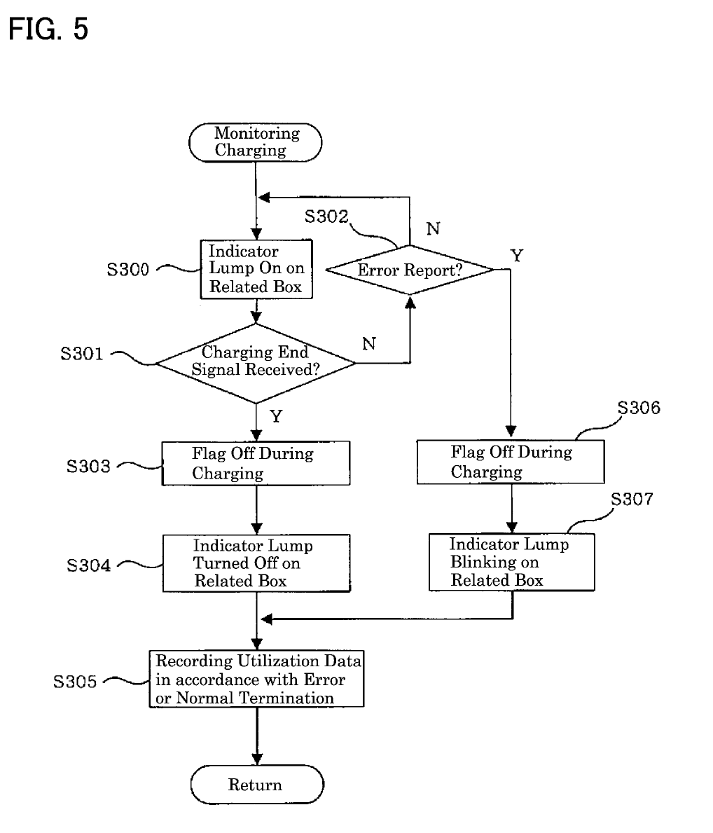

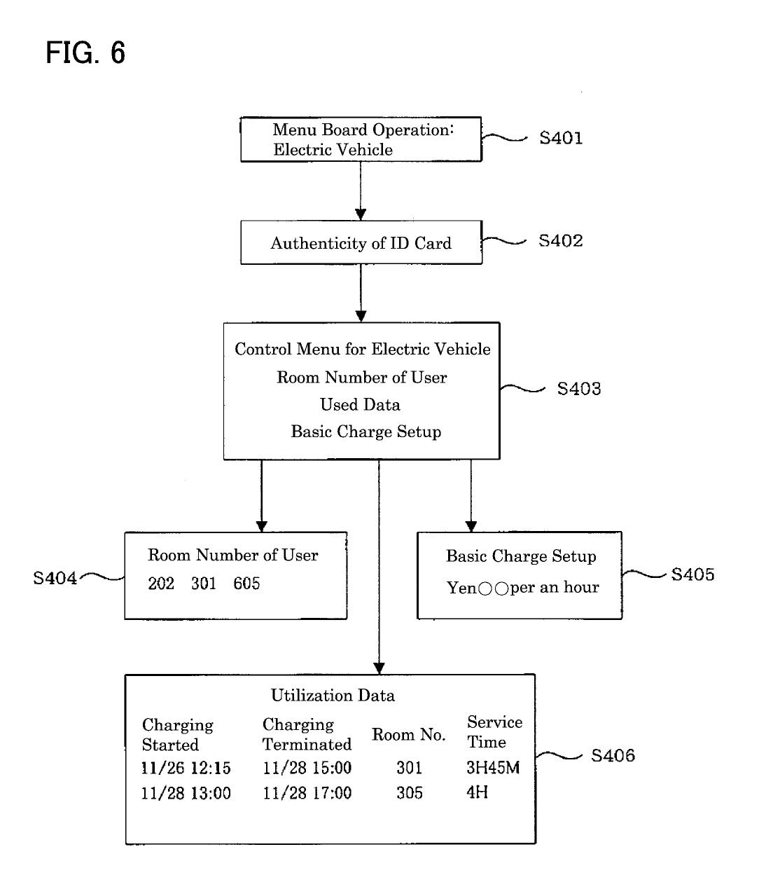

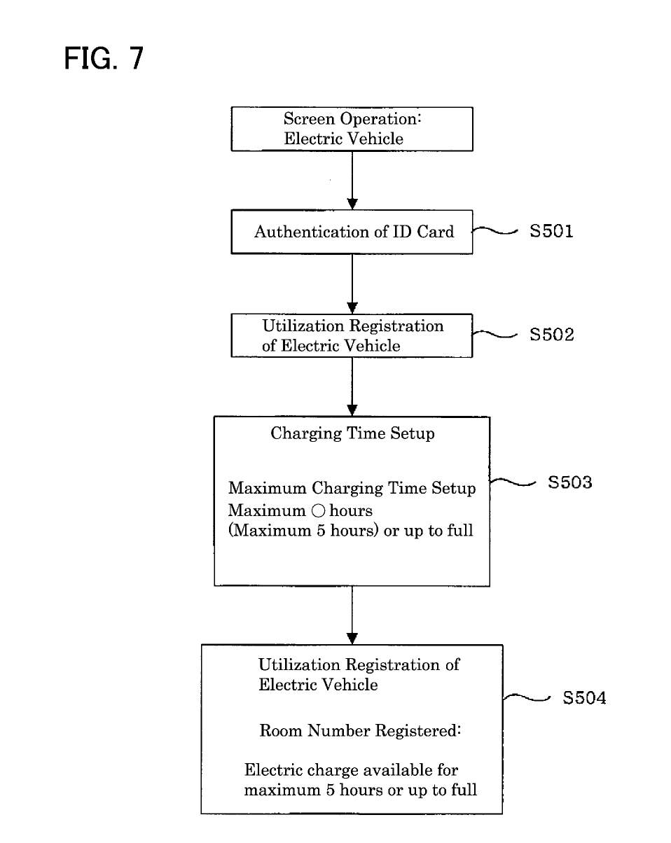

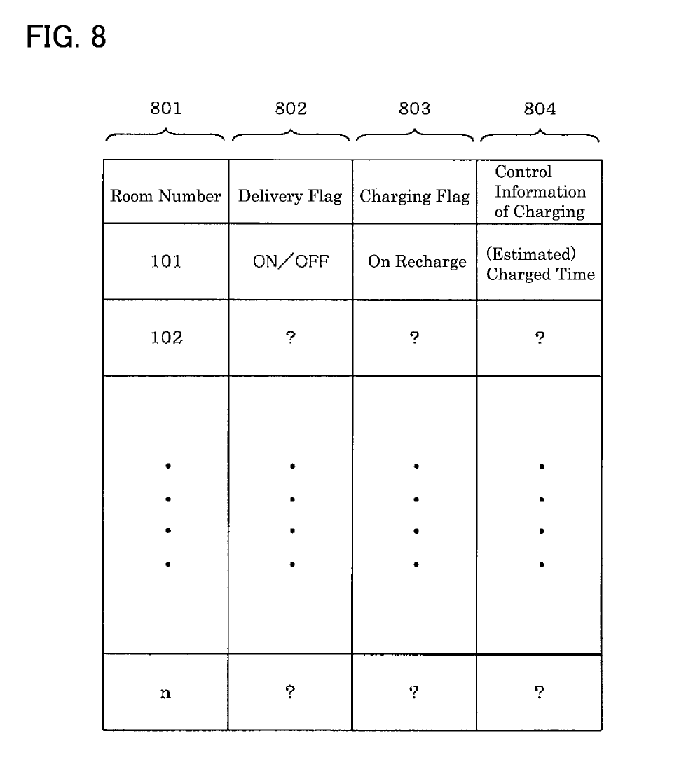

### BRIEF DESCRIPTION OF DRAWINGS

[FIG. 1] A block diagram showing main sections of a charging system for electric vehicles in accordance with the present invention;

[FIG. 2] A block diagram showing the entire configuration of the charging system for electric vehicles in accordance with the present invention;

[FIG. 3] A first flow chart indicating the control sequence of an electrification controller in the charging system of electric vehicles in accordance with the present invention;

[FIG. 4] A second flow chart indicating the control sequence of a delivery box controller in the charging system of electric vehicles in accordance with the present invention;

[FIG. 5] A third flow chart indicating the charging and monitoring sequence in the delivery controller in the charging system of electric vehicles in accordance with the present invention;

[FIG. 6] A fourth flow chart indicating the control sequence of interrogation controlled by the delivery box controller in the charging system of electric vehicles in accordance with the present invention;

[FIG. 7] A fifth flow chart indicating the control sequence for fixing the charging requirements controlled by the delivery box controller in the charging system of electric vehicles in accordance with the present invention;

[FIG. 8] A table indicating control factors used in the delivery box controller in the charging system of electric vehicles in accordance with the present invention.

### DESCRIPTION OF EMBODIMENTS

Embodiments are described hereinafter with reference to the attached drawings regarding the charging system of electric vehicles suitable to application to apartment buildings such as condominium buildings as an example for carrying out the present invention.

### Embodiments

FIG. 1 shows main sections of a charging system for electric vehicles in accordance with the present invention, and FIG. 2 shows the entire configuration of this charging system.

The following is a description of the hardware construction in the charging system for electric vehicles in accordance with the present invention with reference to FIGS. 1 and 2.

The charging system of electric vehicles in this embodiment may be installed in an apartment building such as a condominium building, and as shown in FIG. 2, the charging system comprises electrification receptacles (jacks) 205, 205 . . . and medium-speed chargers 207, 207 . . . disposed as charge output means on a parking space 208.

For the purpose of only illustration, FIG. 2 shows several receptacles 205 and medium-speed chargers 207 on parking space 208 that are assigned to each resident, and parking space 208 may include a space for only an electric vehicle (including electric bicycles) owned by residents or a recharge-dedicated space for common use available after residents bring his or her electric vehicles from the parking positions to the recharge-dedicated space. Electric vehicles may be those owned by residents or those shared (car shared) by residents in the apartment buildings. Shared electric vehicles (shared cars) are maintained for reservation of electric charging through an appointment or a reservation set up according to the predetermined procedure.

In this embodiment, a total control circuit (in FIG. 1) for a delivery box 100 may be used for controlling the electrically charging system of electric vehicles. As shown in FIG. 2, delivery box 100 comprises an operation board 151 handled when residents receive delivered baggage in apartment buildings or when inquiries are made regarding the charging managements or services discussed later. Also, operation board 151 may have a card reader or card interface for reading information recorded in and from an ID (IC) card as authentication means of residents (or forwarders).

Disposed under operation board 151 is a key box 160 available for car sharing discussed later in detail, however, delivery box 100 does not necessarily have key box 160 without the car sharing system.

Delivery box 100 is connected to the charging hardware such as electrification receptacles 205, 205 . . . and medium-speed chargers 207, 207 . . . on parking space 208 through cables 204.

The total control circuit (FIG. 1) in delivery box 100 is connected to a control system 401 at a remote position through Internet 400 (otherwise, communication networks may be used such as dedicated or public communication lines without limitation to Internet). Control system 401 may carry out control of an operation for charging fees on charging electricity as mentioned below (or a part or all of control operations for delivery box), however, in this embodiment, distant control system 401 may take only control on charging fees of electrification. Control system 401 is connected to a fee-payment system 402 that has an interface 403 for charging the fees incurred for electrification in bank account through fee-payment system 402 based on the electrification control information as mentioned below recorded in the administrative report database to pay the fees directly from bank accounts of residents. Otherwise, interface 403 may not be connected to a bank debit account system, but it may be a system for issuing bills of electrification fees (for example, in the name of the management association as a claimant).

FIG. 1 illustrates a practical and detailed example of the general embodiment shown in FIG. 2. A block depicted by a reference numeral 100 in FIG. 2 denotes the delivery box 100 in FIG. 1, and a circuitry in block 100 of FIG. 2 denotes a total control circuit in delivery box 100 that has substantially compatible electric configuration with those in prior art control circuit for controlling only a delivery box.

In the embodiment shown in FIG. 1, an electrification controller 200 is used to electrically charge or recharge electric vehicles or cars 300 (shown as a single automobile shape) as a separated block from delivery box 100 although electrification controller 200 is electrically connected to delivery box 100 for electric control and signal or data communication, and electrification controller 200 may be disposed within a casing of delivery box 100 or located at a predetermined position near parking space 208.

The following is a detailed description on total control circuit in delivery box 100, electrification controller 200 for charging up electric vehicles 300 and their peripheral circuits.

The total control circuit or means in delivery box 100 may comprise a delivery box controller 101 made up mainly of one or more CPUs (Central Processing Unit) such as microprocessors, a ROM (Read Only Memory) 121 storing given control protocols as stated below, a RAM (Random Access Memory) 122 used as a working area for carrying out the control protocols to be hereinafter described, and etc. An interface 103 may comprise a network interface communicating with control system 401 and an inner interface communicating with operation board 151 (not shown in FIG. 1).

A storage 104 is comprised of a plurality of article storage boxes each of which comprises an outer or front door operated mainly by carriers or forwarders, an inner or private (common) door operated mainly by residents of apartment buildings and electrically operated locking devices 1042, 1043 for locking and unlocking these doors.

In this case, there is a possible utility manner where each resident does not exclusively have a single article storage box for common or shared use so that forwarders may put a delivered article in a specific article storage box upon each arrival of the article, specifying the addressee or receiver of the delivered article by means of an outer or front operation board, however this embodiment is described in a case that a single article storage box is assigned to each resident (each household).

Also, each article storage box has an indicator 1041 that comprises an LCD (Liquid Crystal Display) or LEDs (Light Emitting Diodes) capable of optically representing characters or displaying its blinking, lighting and extinct states so that various lighting states of indicators 1041 may be used to display various conditions of the article storage box, for example on whether or not an article storage box currently contains a delivered article, and moreover in this embodiment, indicator 1041 may be used to display information on charging operation of electric vehicles.

In a similar manner to those in prior art delivery box, delivery box controller 101 may authenticate a user to thereby unlock or lock locking devices 1042 and 1043 when a resident (or forwarder) accesses operation board 151 with its ID card to deposit a delivered article in an article storage box or to take out the delivered article from the article storage box.

Delivery box controller 101 has an interface 102 for communicating an electrification controller 200 that contains another interface 203 specified to mutually communicate between interfaces 203 and 102. Optional specifications may be used for communication interface between delivery box controller 101 and electrification controller 200, and for example, they may have interfaces in an appropriate bundle of control lines or network interfaces as under Standards 802.3 of IEEE (Institute of Electrical and Electronics Engineers).

Electrification controller 200 comprises a control circuit 201 that includes delivery box controller 101 (CPU), ROM 121 and RAM 122 making up delivery box controller and a power supply circuit 202. In a simplest configuration, power supply circuit 202 may comprise a switch circuit for supplying electric outputs from commercial AC power source (not shown in the drawings) of simple phase/three phase (100 volts or 200 volts) to electrification receptacle 205 and a medium-speed charger 207 (FIG. 1 shows a single electrification receptacle 205 and a single medium-speed charger 207 for illustrative purpose).

A cable 302 for electrification is connected to a charging circuit 303 in electric vehicle 300 equipped with a battery 304, and cable 302 has a plug 301 at the tip connectable to electrification receptacle 205 to provide electric outputs from power supply circuit 202 for charging circuit 303.

Electrification receptacle 205 has a card reader 211 attached thereto to authenticate a user at the position of electrification receptacle 205 as mentioned later. Card reader 211 has a card interface (not shown in the drawings) for reading information in an ID (IC or the like) card accessed thereto and a display provided with LCD and etc.

Charging circuit 303 in electric vehicle 300 comprises a rectifying circuit for converting AC inputs through a cable 302 into DC (direct current) inputs for charging, an electric current controller for producing charge current of the amount appropriate for charging up battery 304 dependent on various requirements including charged amount in battery 304, and a charge control circuit for monitoring a charged level in battery 304 to interrupt input current from cable 302 into battery 304 when fully charged.

Medium-speed charger 207 may comprise a charging circuit for electrically charging a battery 304 for example removed from electric vehicle 300 for quick charge, and may comprise for example a charging circuit designed to produce charging outputs with its low direct current under charging current-voltage property or curve to efficiently charge up battery 304 for a short time.

There may be often the case that full charge of battery 304 in electric vehicle 300 (through electrification receptacle 205) requires a long charging time for example all night and all day. Accordingly, medium-speed charger 207 serves to charge up batteries to the necessary and full level for a short charging time even in an expected situation of only short drive time. Also, medium-speed charger 207 comprises a card reader 211 for authentication of users on site for charging.

Cables 204 are used to electrically connect between electrification receptacle 205 and control circuit 201 through power supply circuit 202, between medium-speed charger 207 and control circuit 201 through power supply circuit 202 and between both card readers 211 and control circuit 201 through power supply circuit 202.

Operation of the charging system as configured above is described hereinafter with reference to FIGS. 3 to 8. The following embodiment shows an example of charging up electric vehicle 300 through electrification receptacle 205, however, another embodiment of charging via medium-speed charger 207 is omitted because there is only one difference in that unshown cable is used to connect battery 304 with medium-speed charger 207 for charging through medium-speed charger 207 in lieu of cable 302 connecting between electrification receptacle 205 and electric vehicle 300 through plug 301, and these charging systems utilize a similar authentication through card reader 211.

FIGS. 3 to 7 show flow charts of control sequence used in this charging system; FIG. 3 shows a first flow chart of the charging control sequence by control circuit 201 in electrification controller 200; FIG. 4 shows a second flow chart of the charging control sequence of delivery box controller 101; and FIG. 5 is a third flow chart of the charging-monitoring sequence by delivery box controller 101. In addition, FIG. 6 is a fourth flow chart of the interrogation control sequence controlled by delivery box controller 101; FIG. 7 is a fifth flow chart of the control sequence for fixing the charging requirements controlled by delivery box controller 101; and FIG. 8 is a control table available to delivery box controller 101.

Control procedure or protocols of delivery box controller 101 may be stored in ROM 121 as control programs in CPU that constitutes delivery box controller 101, and control procedure or protocols of control circuit 201 in electrification controller 200 may be stored in a similar ROM within control circuit 201 as control programs in CPU that constitutes control circuit 201.

Operations of control circuit 201 in electrification controller 200 are described hereinafter with reference to FIG. 3. Upon charging up electric vehicle 300, a resident connects plug 301 of cable 302 extended from electric vehicle with electrification receptacle 205 and presents or moves the private ID card to or toward card reader 211 in electrification receptacle 205 to allow card reader 211 to read the resident's ID (Identification) information from the card in Step S101.

Then, in Step S102, control circuit 201 in electrification controller 200 establishes communication with delivery box controller 101 through interfaces 203, 102 to transmit to delivery box controller 101 the ID information read by card reader 211. Delivery box controller 101 compares received ID information with table data shown in FIG. 8 mentioned below to decide on whether or not the ID information is one for residents allowed to charge up the electric vehicle, and then delivery box controller 101 returns the resultant decision or authentication signal to control circuit 201 in electrification controller 200.

When control circuit 201 in electrification controller 200 receives information of no authentication in Step S102, a display in card reader 211 shows an “Error” indication in Step S103 (In addition, operation board 151 may also show a similar “Error” indication.).

In Step S104, usage or utilization information is registered regarding electric charge to the electric vehicle. Here, control circuit 201 transmits to delivery box controller 101 information including start and (expected) termination clock times of charging, etc., and delivery box controller 101 stores this information in table data shown in FIG. 8 associating with the previously transmitted ID information. A method for expecting termination time of charging is mentioned hereinafter.

In Step S105, control circuit 201 regulates power supply circuit 202 and turns on AC outputs from power supply circuit 202 for charging to start supply of charging current to charging circuit 303 in electric vehicle 300.

In Step S107, control circuit 201 starts monitoring of charging AC outputs from power supply circuit 202, and when control circuit 201 detects for example electric short circuit or leakage of electricity, it ceases charging AC outputs from power supply circuit 202, and it establishes communication with delivery box controller 101 to inform it of error or abnormality occurrence with the error number associated therewith (in Step S108). Also, when maximum charge time is set (as in Step S503 of FIG. 7) and maximum charge time has elapsed, control circuit 201 may also cease charging as error occurrence.

When control circuit 201 monitors and detects normal termination of charging AC outputs, processing moves on to Step S109. The time point for termination of charge is determined for example by charging circuit 303 in electric vehicle 300. For example, typically a charge control circuit may be provided in such a charging circuit 303 so that the charge control circuit may monitor a charged level in battery 304 and shut off input power through cable 302 when battery 304 is fully charged, and for this purpose, control circuit 201 and power supply circuit 202 may monitor charging AC current and decide termination of charge, at the time the amount of charging AC current flow becomes little.

When power supply circuit 202 detects termination of charging, control circuit 201 turns off charging AC output in Step S109 for termination of charging (in Step S110), making a report of termination of charging to delivery box controller 101 (in Step S111). Here, delivery box controller 101 produces billing or charging data on electrification, stores it along with ID data or sends out the information to control system 401 through Internet 400. According to the simplest calculation, the billing amount may be computed based on charging time, the difference between start and termination clock times of charging. Otherwise, control circuit 201 may receive an output from a current-detecting circuit provided in power supply circuit 202 to accumulate a total amount of electric energy required for charging and inform delivery box controller 101 of the total amount.

In Step S112, delivery box controller 101 decides on whether or not any inquiry operation is made through operation board 151. When any inquiry operation has been made, the following inquiry control procedure (FIG. 6) is carried out through used operation board 151.

Then, charging control procedure of delivery box controller 101 will be described hereinafter with regard to FIG. 4.

In Step S201 of FIG. 4, delivery box controller 101 decides on whether or not it receives ID information (read out from ID card) sent from control circuit 201 of electrification controller 200. When delivery box controller 101 receives ID information, it decides on whether or not the ID information is one for residents allowed to charge up the electric vehicle with reference to table data in FIG. 8 as discussed below. When ID information is authenticated, delivery box controller 101 forwards an acknowledgement response (ACK) to control circuit 201 of electrification controller 200 in Step S203, to the contrary, when ID information is not authenticated, delivery box controller 101 forwards an error response to control circuit 201 of electrification controller 200 in Step S204.

When delivery box controller 101 forwards an acknowledgement response (ACK) to control circuit 201 in Step S203, control circuit 201 starts charging as above-mentioned, turning on a charge flag 803 in table data of FIG. 8 as mentioned below.

Then, charge monitoring procedure of delivery box controller 101 is described hereinafter with reference to FIG. 5. This charge monitoring procedure may be carried out as a timer-interrupt process triggered at regular intervals after charge flag 803 is turned on during charging in the charge control procedure of FIG. 4. In addition, a single charge monitoring procedure of FIG. 5 is triggered each time one charging job is commenced for single electrification receptacle 205.

In Step S300 of FIG. 5, indicator 1041 of delivery box related to ID card read out in S101 of FIG. 3 is kept lighted in a predetermined mode to announce “ON RECHARGE” of electric vehicle 300 to the resident who has triggered the charging operation. The resident can see or watch lighting of indicator 1041 on the private delivery box to confirm continuation of charging.

Subsequently, in Step S301, delivery box controller 101 decides on whether or not it receives a normal charge termination report from control circuit 201 of electrification controller 200 (in Step S109 of FIG. 3). Upon receipt of normal charge termination report by delivery box controller 101, processing moves on to Step S303.

Unless receiving the normal charge termination report by delivery box controller 101, it decides on whether or not it receives an error report (in Step S108 of FIG. 3) from control circuit 201 of electrification controller 200. Upon receiving the error report by delivery box controller 101, processing moves on to Step S306.

When receiving normal charge termination report, delivery box controller 101 turns off charge flag 803 in FIG. 8 in Step S303 and also simultaneously turns off indicator 1041 on related delivery box (otherwise, another indicator of different light color may be turned on). The resident can see the condition of indicator 1041 to confirm that triggered charging is normally terminated.

On the other hand, when charging is terminated with error, delivery box controller 101 turns off charge flag 803 in Step S306 and simultaneously converts indicator 1041 on relevant delivery box into a predetermined blinking condition. Accordingly, the residents can see or watch the condition of indicators 1041 to confirm that the triggered charging is terminated with error.

Described indicative conditions of indicators 1041 in Steps S300, S303 and S306 may include its lighting, blinking, darkened or color-changed lighting condition of LEDs as examples of optical signals, and otherwise, for example, other display means may be used such as LCD to represent information on charge operations during the foregoing steps in more detail by display means for indicators 1041 with letters like “ON RECHARGE”, “TERMINATION OF CHARGE”, or “ERROR TERMINATION OF CHARGE” or with other appropriate symbols or phrases.

In Step S305, recorded in memory means in association with ID information of the resident is the utilization data regarding charging services offered to the resident depending on the result of normal or error termination of charging treatment (or utilization data is transmitted to control system 401 through Internet 400). For example, recorded utilization data may contain information such as start and termination clock times of charging, time required for charging, an amount of fees required for charging service, etc. (or transmitted to control system 401).

FIG. 6 indicates the inquiry control procedure controlled by delivery box controller 101. When the predetermined operation (shown in Step S112 of FIG. 3) is carried out on operation board 151, while designating any inquiry job regarding charging treatment for electric vehicle, delivery box controller 101 performs the inquiry control procedure in FIG. 6. This embodiment shows the procedure for controlling the inquiry treatment through operation board 151 only by an administrator authorized to control the delivery box and the charging system of electric vehicles, however, residents (users for charging system of electric vehicles) may also make use of similar user interfaces. Modified embodiments therefor will be described where necessary.

Step S401 means that an administrator (a resident) selects an inquiry item regarding “electric vehicles” for example in a top menu indication shown on a touch panel of operation board 151.

When one of inquiries is selected, the operator presents or moves the private ID card to or toward card reader in operation board 151, and delivery box controller 101 decides on whether or not ID information read out from ID card is one for persons allowed to make inquiries on electric vehicles. When ID information is authenticated, inquiry operations on Step S403 and subsequent Steps are permitted (when ID information is not authenticated, error processing not shown in the drawings is done). In this case, when ID information is genuine one for the authorized administrator or for an allowed resident (a user for the charging system), control circuit 201 may select different user interfaces for the administrator or resident. The following is a description of an example where the authorized administrator uses his or her ID card for card reader to select the user interfaces for the administrator.

In Step S403, touch panel of operation board 151 indicates a further control menu for “Electric Vehicle” in Step S401. Examples of further menu in FIG. 6 to be selected are as follows:

Room Numbers of Residents who have used the charging system

Utilization Data

Basic Charge (Fee) Setup

When each item is selected in menu, touch panel of operation board 151 indicates respectively output displays as shown in Steps S404, S405 and S406.

When Room Number of Resident is indicated in Step S404, touch panel of operation board 151 shows room numbers of residents who have utilized the charging system until now based on utilization data recorded in RAM 122. Actually, Room Number in Step S404 shows a fact that residents of Room Nos. 202, 301 and 605 have utilized the charging system.

“Basic Charge (Fee) Setup” in Step S405 indicates Yen∘∘ per an hour as a currently set basic charge (fee). Here, it demonstrates a menu interface used by the administrator to enable to make modifications to “Basic Charge Setup”. To this end, for example, the administrator may select numerals on touch panel to enter different amount for charge (fee) setup. An amount of charge (fee) may be computed from electrically charging time and amount of Basic Charge Setup per an hour. Touch panel may indicate only the set amount of current basic charge (fee) through user interfaces utilized by users.

In an indication interface “Utilization Data” in Step S406, touch panel may show start and termination clock times of charging, room numbers and times for charging in the shown format based on utilization data recorded in RAM 122 in connection with past charging jobs. For easier understanding of indicated contents, sorting order of data may be changed for each item of start and termination clock times of charging, room numbers and times for charging by selecting each item on touch panel.

FIG. 7 shows a fifth flow chart of the control sequence for fixing the charging requirements regulated by the delivery box controller 101. This sequence also shows the procedure for controlling the inquiry treatment through operation board 151 only by an administrator authorized to control the delivery box and the electrically charging system of electric vehicles, however, residents (users utilizing the charging system of electric vehicles) may also make use of similar user interfaces. Modified embodiments therefor will be described where necessary.

In the sequence shown in FIG. 7, similarly to the menu board operation shown in FIG. 6, firstly an ID card is authenticated. When successfully authenticated, menu operations in and after Step S502 are allowed.

When ID card for the administrator (user) is successfully authenticated, Step S502 enters a submenu or subroutine “Utilization Registration of Electric Vehicle”.

Operations in menu “Utilization Registration of Electric Vehicle” and thereafter may include other various operations for registration and change than those shown in FIG. 7, however, it represents herein one example of the initial setup procedure carried out for example when residents request an electrically charging service of electric vehicles.

Interface in Step S503 may set a restriction of electrically charging time. One example herein may set the maximum charge time: 5 hours within which residents can receive the charging service at their request. The maximum charge time may be set according to a resident's request. The maximum charge time may be used as one of requirements for error termination of charging in Step S107 of FIG. 3.

An interface in Step S504 may register a room number of a resident who has requested the charging service. Here, the room number may be entered from operation board 151 and then registered in memory means, and after the registration, operation board 151 displays the registered room number as shown in Step S504 and content of maximum charge time set through interface in Step S503.

Also, when ID card of resident is exhibited, operation board 151 may display the last indications in interface of Step S504 including the room number in connection with service registration related to ID card, content of maximum charge time already set in interface of Step S504, etc.

FIG. 8 shows an example of control table data used by delivery box controller 101 in charging up the electric vehicles under control above-mentioned.

Table data in FIG. 8 is allocated and recorded in a part of RAM 122. As shown in FIG. 8, recorded table data may include room number 801 of residents, delivery (arrival) flag 802 indicating on whether or not articles arrive at article storage boxes assigned to residents, charging (electrification) flags 803 kept on during the course of charging job triggered by residents with the ID cards, control information fields 804 of charging, etc.

Control information field 804 of charging may comprise subfields or subareas for storing various data such as start and termination clock times of charging, etc., and specifically, after the data has firstly been recorded in subfields, then they are transferred to and stored in utilization database (the administrative report database) after completion of charging job. Also, as shown, termination clock time of charging may be recorded and may be renewed by means of various predictive methods to display to residents the predicted clock time of charging on operation board 151 (or on indicator 1041). Termination clock time may be predicted in accordance with several predictive methods for example one of which firstly measures change in electric current flow running through electrification receptacle 205 to calculate the timing of meeting the full charge requirement or another one of which simply computes the remaining time to the maximum charge time to use the same as a predictive time.

The foregoing arrangement is notably advantageous because it may provide a single management/control means (namely, delivery box controller 101 or control system 401 working therewith) that can carry out integrated or unified control of delivery box, electrification of electric vehicles and its billing process to produce the whole system in the simplified and inexpensive configuration. Also, the simple management/control means (namely, delivery box controller 101 or control system 401 in cooperation therewith) can manage in the integral fashion control data of related services including utilization data on delivery boxes and battery charge of electric vehicles and billing data, and in addition, administrators and residents or users may manage or review the various management data as above by means of user interfaces (for example operation board 151) in the management/control means.

In addition, residents can conveniently confirm the current status of battery charging job by watching the indicator 1041 provided in the assigned private article storage box of delivery box 100 during operation of the charging job so that residents do not need to move to the charging position of the electric vehicles. Therefore, residents can easily and readily make sure of the current status of charging job even though the charging position of the electric vehicles is away from the installation site of delivery box (is typically installed in the vicinity of an entrance of the apartment building or along a passageway through which residents frequently come and go).

The administrator who does management duties on charging electric vehicles, can confirm the status of utilization on charging services of electric vehicles (in FIG. 6) after authentication of the private ID card (the management card) at operation board 151 of delivery box 100, and also can do setting and registration operations on charging services of electric vehicles (in FIG. 7). When the same administrator does both management duties on charging electric vehicles and on delivery box 100, these management duties may be followed out by means of the same ID card (the management card) and same user interfaces.

Also, users who can receive charging services of electric vehicles can confirm the status of utilization on charging services of electric vehicles (in FIG. 6) after authentication of private ID cards (management cards) at operation board 151 of delivery box 100, and also can confirm registration operations on charging services of electric vehicles (in FIG. 7). Also, residents can conveniently make interrogations and operations regarding charging services of electric vehicles by means of assigned ID cards (management cards) and same user interfaces.

Delivery box controller 101 or control system 401 remote from and collaborating with delivery box controller 101 may be used for both managements in charging services for electric vehicles and delivery boxes, and for example, utilization and billing data of charging services for electric vehicles and delivery boxes can be referred and confirmed at delivery box controller 101 or control system 401 remote from and collaborating with delivery box controller 101.

Thus, the present embodiments enable to manage or control charging services of electric vehicles through delivery box controller 101 while combining, integrating or unifying the control system for delivery box and the electrically charging control system for electric vehicles to thereby advantageously reduce the total cost incurred for the whole facilities and system management required in apartment buildings.

In addition, when an electric vehicle to be charged is shared (car sharing) by a plurality of users or residents, it needs to make a reservation for administrative convenience, and such a reservation can be made by access to delivery box controller 101 or distant control system 401. In this case, single management/control means (namely, delivery box controller 101 or control system 401 working therewith) may be used for management of delivery box, charging control of electric vehicles, billing process control thereof and also management in reservation of electric vehicles (or including billing control of fee-based service rendered for utilization of electric vehicles) to produce the whole system in the simplified and inexpensive configuration. Also, the simple management/control means (namely, delivery box controller 101 or its collaborating control system 401) enables to manage in the integral fashion control data of related services including utilization data on delivery boxes and battery charge of electric vehicles and billing data, reservation and utilization and usage fees of electric vehicles. In addition, the administrator and residents or users may favorably manage or review the various management data as above by means of user interfaces (for example operation board 151) in the management/control means.

The foregoing embodiments are described in connection with the phrase: “delivery box”, however, article storage boxes of delivery box 100 is not limited to one used to receive, store, deposit or place a delivered article therein. Article storage box may be used to receive mails or postal matters when the article storage box is assigned to individual resident of apartment building. In other words, these embodiments may substitute article storage boxes in delivery box 100 for mailboxes assigned to individual resident. In these cases, the foregoing effects and advantages without their modification also apply to article storage boxes as mailboxes.

### INDUSTRIAL APPLICABILITY

The present invention may widely be reduced to practice where apartment buildings comprise an article storage device such as home-delivery box and also facilities of charging up electric vehicles owned or shared by residents therein.

### REFERENCE SIGNS LIST

100 A delivery box, 101 A delivery box controller, 102 An interface, 103 An interface, 121 A ROM, 122 A RAM, 151 An operation board, 160 A key box, 200 An electrification controller, 201 A control circuit, 202 A power supply circuit, 203 An interface, 204 A cable, 205 An electrification receptacle, 207 A medium-speed charger, 208 A parking space, 211 A card reader, 300 An electric vehicle, 301 A plug, 302 A charging cable, 304 A battery, 308 A charging circuit, 400 Internet, 401 A management system, 402 A fee-payment system, 403 An interface, 801 Room Number, 803 Charging Flag, 804 Control information of charging 1041 Indicators 1042, 1043 Electrically operated locking devices

1. A charging system of electric vehicles comprising:
a delivery box having a plurality of article storage boxes each locked or unlocked by an electrically operated locking device, the article storage boxes being used to receive delivered or mailed articles in apartment buildings,
control means for controlling locking and unlocking of the electrically operated locking devices,
a power supply circuit for electrically charging the electric vehicles, and
an electrification controller for controlling the power supply circuit,
wherein the control means regulates electrically charging services of the electric vehicles through the power supply circuit and electrification controller in addition to controlling operation of the locking devices for the article storage boxes.

2. The charging system of the electric vehicles in claim 1, wherein said control means comprises an operation board used for utilization and management of the article storage boxes, and
the operation board allows for utilization and control of the article storage boxes and also allows for reference and setting operation to utilization data related to charging services of the electric vehicles through the operation board.

3. The charging system of the electric vehicles in claim 2, wherein authentication means is provided to allow for utilization and management of the article storage boxes when residents or administrator presents the authentication means to the operation board, and
the authentication means serves also as an authentication means for charging services of the electric vehicles.

4. The charging system of the electric vehicles in claim 3, wherein means for reading the authentication means is arranged in the vicinity of charge-output means of the power supply circuit for electrically charging the electric vehicles.

5. The charging system of the electric vehicles in claim 3, wherein each of the article storage boxes is assigned to individual resident,
an indicator is provided in each article storage box to display the status of the article storage box,
the control means causes the indicator to display information on charging services of the electric vehicles.

6. The charging system of the electric vehicles in claim 1, wherein the control means establishes communication with a remotely situated control system through a network to share utilization data on the article storage boxes and on charging services of the electric vehicles and billing data between the control means and control system.
